(19) United States
(12) Patent Application Publication
(10) Pub. No.: US 2003/0215156 A1
(43) Pub. Date: Nov. 20, 2003

(54) Method and computing device for determining the pixel value of a pixel in an image

(75) Inventor: Hans-Peter Rieger, Walsdorf (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/437,584

(22) Filed: May 14, 2003

(30) Foreign Application Priority Data
May 14, 2002 (DE) 10221389.5

(51) Int. Cl. G06K 9/36

(52) U.S. Cl. 382/276

(57) ABSTRACT

In a method and computing device for determining a pixel value of a target pixel of a target image, the target image being generated by an affinity transformation of a source image comprising source pixels, by means of a bi-non-linear interpolation, the pixel values of a specific number of source pixels of the source image that are relevant for the determination of the pixel value of the target pixel of the target image are weighted with a non-linear weighting function and summed after their weighting.

### BACKGROUND OF THE INVENTION

1. Field of the Invention

The present invention is directed to a method for determining a pixel value of a target pixel of a target image, the target image being generated by an affinity transformation of a source image composed of source pixels. The invention is also directed to a computing device that employs a weighting matrix for determining a pixel value of a target pixel of a target image.

2. Description of the Prior Art

An affinity transformation is a rotation, a stretching, a zooming, a shift or a roaming of the source image or a pixel shift or a sub-pixel shift of source pixels of a source image. In such an affinity transformation there is the problem of determining a pixel value, i.e. a color value or a grayscale value, for a target pixel of the transformed source image.

The determination of pixel values of target pixels of a target image ensues on the basis that all target pixels of the target image are sequentially mapped in their source image with the inverse transformation, for example a back-rotation. The orientation of a back-transformed target pixel, which is also referred to as virtual source pixel, is assumed to be orthogonal to the orientation of the real source pixel of the source image. The mid-point coordinates of this back-transformed target pixel, however, usually do not correlate with a specific, real source pixel but are shifted by a defined vector.

The following methods are known form the literature for determining pixel values of target pixels of a target image after an affinity mapping of a pixel-oriented source image.

a) Nearest neighbor method: In this method, that source pixel of the source image is sought whose mid-point has the smallest spacing from the mid-point of the back-transformed target pixel. The pixel value of the real source pixel found in this way is taken as the pixel value of the target pixel. High-performance calculations are possible by means of this method, with practically no loss of contrast. The information loss due to lower adherence to detail, however, is disadvantageous. Some source pixels, particularly those that are located close to the rotational center given a rotation of the source image, are multiply employed for the determination of pixel values, whereas other source pixels located at the periphery are not employed. Further, the step effect (aliasing) occurs, particularly given high-contrast, highly contoured subjects, for example catheters imaged in medical images.

b) Bi-linear interpolation: In this method those four, real pixels on which the back-transformed target pixel comes to lie are usually sought.

Their pixel values are normalized, weighted and added proportionally to the area that the back-transformed target pixel covers and the individual, real source pixels are allocated to the target pixel as the pixel value. The advantage of this method is in a low loss of detail and a low step effect. However, the accompanying loss of contrast, loss of sharpness (spatial frequency, topical resolution) as well as the complex computing algorithms for this method are disadvantageous.

c) Bi-cubic interpolation: This method is similar to the bi-linear method, however, a larger region of source pixels, for example 4*4 source pixels, is weighted and utilized for the interpolation. The advantages of this method are-a lower loss of contrast than in bi-linear interpolation as well as in less of a step effect. In practice, this method is usually utilized only for enlargement transformations. The very complicated computing algorithms are a disadvantage of this method.

The disadvantages of the nearest neighbor method arise because a large area of the back-transformed target pixel can be allocated to an incorrect source pixel (75% in an extreme case). The informational content of the target images drops as a result. The disadvantages of the bi-linear method arise because the pixel value of the target pixel always lies between the extreme values of the source pixels because of the averaging. The contrast and the resolution thus decrease.

### SUMMARY OF THE INVENTION

An object of the present invention is to provide a method of the type initially described wherein the image quality of the target image, i.e. the contrast and the topical resolution, is improved in an affinity transformation. A further object of the invention is to create the pre-conditions for high-performance calculations of target images with improved image quality in affinity transformations.

The first object is inventively achieved by a method for determining a pixel value of a target pixel of a target image, the target image being generated by means of an affinity transformation of a source images composed of source pixels, by means of a bi-non-linear interpolation, wherein the pixel values of a specific number of source pixels of the source image that are relevant for the determination of the pixel value of the target pixel of the target image are weighted with a non-linear weighting function and are summed after their weighting. Those source pixels of the source image are relevant that, following the inverse transformation of the target pixel into the source image, have an overlap area with the back-transformed target pixel. The non-linear weighting function represents the relationship between the overlap area and the pixel value of the overlapped source pixel. The graph of the non-linear weighting function proceeds within an envelope that is demarcated using the same definition and value range from the corresponding graph illustrating the nearest neighbor method and the corresponding graph of the bi-linear method.

The overlap area of the back-transformed target pixel with a relevant source pixel is determined. The pixel value of the relevant source pixel is weighted according to its overlap area with the back-transformed target pixel using the non-linear weighting function, with the pixel value of the source pixel being multiplied by the corresponding weighting. The sum is formed over all weighted pixel values of the relevant source pixels.

For determining the pixel value of a target pixel according to the invention, the pixel values of the relevant source pixels are not weighted according to the nearest neighbor method nor are they linearly weighted with their surface part and summed, but are weighted according to a non-linear characteristic or a non-linear weighting function. This represents a generalization of both the nearest neighbor method and the bi-linear method. With a suitable non-linear weighting function dependent on the application, the image quality of the target image that has proceeded from an affinity transformation can be noticeably improved in this way.

A few pre-conditions must be satisfied in order to be able to implement the method on a high-performance computing machine, for example a DSP (digital signal processor) or an FPGA (field programmable gateway). These limitations are essentially based on the hardware structure with which modern computing machines are currently realized. Fixed point arithmetic, i.e. integer calculations, are allowed on such computing machines, with a LSB (least significant bit)=2-n (with n>0) being permitted. Further, additions, subtractions, multiplications and shift operations are allowed. In contrast, floating point arithmetic, divisions, taking the root and the application of trigonometric functions are not permitted. In one embodiment of the invention, therefore, the non-linear weighting function is defined such that the sum of the weights, for weighting the pixel values of the relevant source pixels for the determination of a pixel value of a target pixel, is one. If the sum of the weights of the (usually four) relevant source pixels were unequal to one, then a normalization would have to be implemented after the addition of the weighted pixel values of the source pixels, which could only be done with an impermissible division.

Instead of one non-linear weighting function dependent on the overlap area of a relevant source pixel with the back-transformed target pixel, in a further embodiment of the invention two non-linear weighting functions f(x) and f(y) respectively dependent on the overlapped path in each of the two coordinate directions of a Cartesian coordinate system are applied. These define the coordinate plane in which the back-transformed target pixel lies, so that the overlap paths in the two coordinate directions are determined instead of the overlap area of the back-transformed target pixel with the relevant source pixel, and a function value is determined for each coordinate direction based on the overlap path and the appertaining non-linear weighting function. The product of the two identified function values is the weight for the pixel value of the relevant source pixel. Since usually neither of the coordinate directions represents a preferred or predominating direction, the same weighting function can be employed for both coordinate directions.

According to one version of the invention, the following applies for one non-linear weighting function:

f(z)=1-f(1-z)

with z as the function variable.

The following accordingly applies for the two weighting functions f(x) and f(y):

f(x)=1-f(1-x)

f(y)=1-f(1-y)

with x and y as the respective function variables.

In another version of the invention, a non-linear weighting function has the definition range [0; 1] and is point-symmetrical within its definition range [0; 1] with the point in a Cartesian coordinate system that lies in the middle of the definition range and the middle of the value range of the non-linear weighting function. In the case of a normalized definition range [0; 1] and a value range [0; 1] derived therefrom, accordingly, a necessary point symmetry of the graph of a weighting function to the coordinates (0.5; 0.5) derives as an adequate criterion.

In an embodiment of the invention the non-linear weighting function can also be a discrete function that usually is employed in a real computing machine for performance reasons insofar as an element (1-z_{Pi}) was discretely defined for each discretely defined element (z_{Pi}). Any arbitrary function f_{z}(z) thus would be suitable as weighting function, even those that are not steady or cannot be steadily differentiated and do not initially has the required symmetry. This symmetry would merely have to be “artificially” produced by section-by-section definition and application of the above-recited equations:

$$f ( z ) = \{ \begin{matrix}{f}_{z} ( z ) & for & 0 \leq z \leq 0.5 \\ 0.5 & for & z = 0.5 \\ 1 - {f}_{z} ( 1 - z ) & for & 0.5 < z \leq 1\end{matrix}$$

According to one embodiment of the invention, a non-linear weighting function is defined such that the pixel value of a relevant source pixel that has a large overlap area with the target pixel compared to the overlap areas of other relevant source pixels receives an over-proportional weight, and the pixel value of a relevant source pixel that has a small overlap area with the target pixel compared to the overlap areas of other relevant source pixels receives an under-proportional weight.

In a version of the invention the weights are adjustable by means of a parameter of the non-linear weighting function, with the sum of the weights for the relevant source pixels always remaining one. As a result of this modified version of the weighting function, the properties of the affinity mapping can be advantageously adapted to the particular requirements.

In another version of the invention, a non-linear weighting function is defined such that the slope of the tangent at the symmetry point of the weighting function lying in the middle of the definition range and in the middle of the value range of the non-linear weighting function can be set by means of a parameter.

According to one embodiment of the invention, the non-linear weighting functions have the following form:

$$f ( x ) = \frac{{2}^{1 / c}}{2} * {( x - 0.5 )}^{1 / c} + 0.5$$

$$f ( y ) = \frac{{2}^{1 / c}}{2} * {( y - 0.5 )}^{1 / c} + 0.5$$

wherein x, y: function variable

c: selectable parameter for setting the weights and the slope of the tangent in the symmetry point.

The object of the invention also is achieved by a computing device for image processing comprising a memory in which a weighting matrix is stored for employment in the determination of the pixel value of a target pixel of a target image in an affinity transformation of a source image. The weighting matrix weights pixel values of source pixels of a source image that are relevant for the determination of a pixel value of a target pixel of a target image in the computing device without floating point arithmetic. The weighting matrix has the same number of rows and columns, and matrix elements weights that are calculated according to the following equation:

f(x,y)=f(x)*f(y),

wherein f(x)and f(y) are non-linear weighting functions with x and y as function variables, respectively. The weighting functions have function values in a definition range [0; 1] that are calculated in substantially equidistant steps, with a weight being derived from the multiplication of a function value f(x) by a function value f(y). The two weighting functions f(x) and f(y) preferably are the same. The use of such a weighting matrix creates the pre-conditions for weighting the pixel values of source pixels relevant for the determination of a pixel value of a target pixel of a target image in an efficient way with high-performance computing machines wherein, as mentioned above, division, taking the root, etc., are not permitted. A weighting matrix is employed as a look-up table in the course of determining the pixel values of the target pixels of the target image from pixel values of source pixels of the source image in an affinity transformation. The weights for the weighting of the pixel values of the source pixels in an affinity transformation, accordingly, are not always calculated online with the non-linear weighting functions f(x) and f(y) but could be already present in calculated form in a weighting matrix and can be taken therefrom for weighting the pixel values of the source pixels.

Since the symmetry conditions of the weighting functions and, accordingly, of the weighting matrix as well are meaningful, the function values f(x=0.5) and f(y=0.5) of the weighting functions are equal to 0.5 by definition according to one version of the invention. Further, the function values of the weighting functions f(x) and f(y) are respectively calculated over only half the definition range, and the function values not directly calculated with the weighting functions f(x) and f(y) are calculated according to the equations

f(x)=1-f(1-x)

and

f(y)=1-f(1-y).

For dimensioning a weighting matrix, in an embodiment of the invention the equidistant step width in the calculation of the weights of a weighting matrix amounts to approximately 5% of the width of a pixel, and the number of columns and rows corresponds to a power of two, and that a weighting matrix is supplemented by one row and one column with zeroes.

### DESCRIPTION OF THE DRAWINGS

FIG. 1 is a block diagram of a medical image acquisition and processing device for practicing the invention.

FIGS. 2 through 6 are graphs for illustrating the relationship of a virtual source pixel to real pixels and for illustrating declarations for determining a non-linear weighting function in accordance with the invention.

FIGS. 7 through 12 are graphs for illustrating the determination of a non-linear weighting function suitable for the weighting of pixel values in accordance with the invention.

FIG. 13 is a graph of a non-linear weighting function in accordance with the invention.

FIG. 14 is a graph of a suitable non-linear weighting function dependent on a parameter in accordance with the invention.

FIG. 15 shows examples of the application of a weighting matrix in accordance with the invention.

FIG. 16 shows a real weighting matrix in accordance with the invention.

### DESCRIPTION OF THE PREFERRED EMBODIMENTS

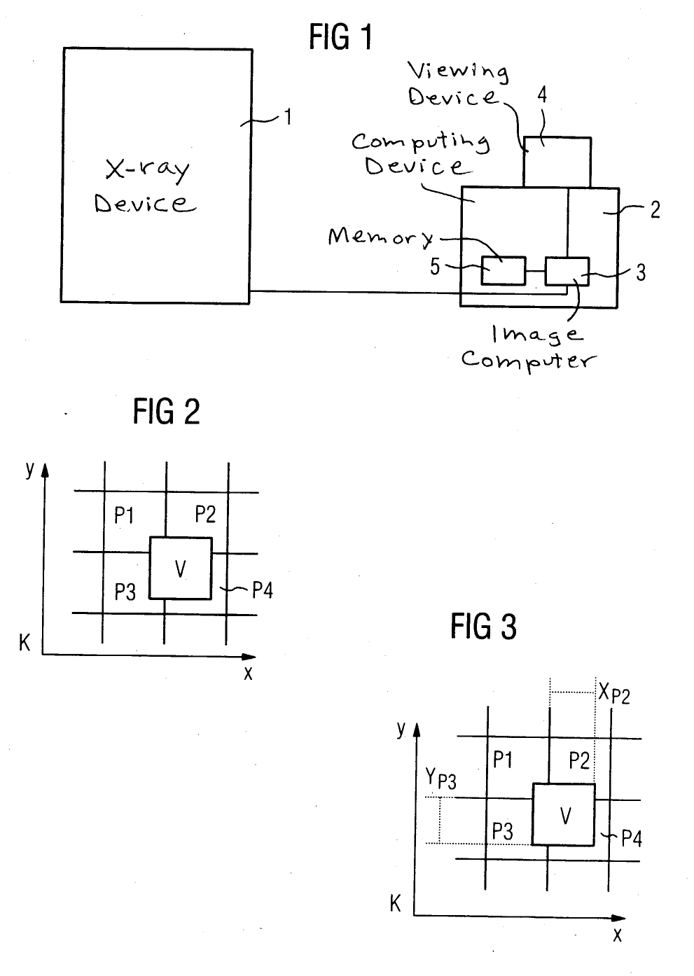

FIG. 1 shows a medical image acquisition and processing device that includes an X-ray device 1 and a computing device 2 (shown in a block diagram) in the present exemplary embodiment. The computing device 2 has an image computer 3, a viewing device 4 and a memory 5. X-ray images of objects and life forms can be acquired with the image acquisition and processing device, displayed on the viewing device 4 and further-processed. The acquisition of the X-ray images preferably ensues using a CCD camera (not shown) or some other device with which X-ray images comprised of pixels can be acquired. “Processing” in the context of the present invention means affinity mappings or transformations of X-ray images. An affinity transformation can be an image rotation, a zoom of the image, a stretching of the image, etc. An affinity transformation, for example a rotation of an X-ray image acquired with the X-ray device 1 and presented on the viewing device 4, moreover, can be initiated with known input means (not shown in detail) connected to the computing device 2, for example a computer mouse or a trackball.

In an affinity transformation of an X-ray source image comprised of source pixels, a pixel-by-pixel re-evaluation of the pixel values of the target pixels of the X-ray target image arising in the affinity transformation is usually required by means of an interpolation of pixel values of source pixels of the X-ray source image. This pixel-by-pixel re-evaluation ensues such that the pixel values of a specific number of source pixels of the X-ray source image that are relevant for the determination of the pixel value of a specific target pixel of the X-ray target image are weighted and summed after their weighting. Those source pixels of the X-ray source image are relevant that, following the inverse transformation of the specific target pixel into the X-ray source image, exhibit an overlap area with the back-transformed target pixel, which is also referred to as virtual source pixel.

It must be assumed in this re-evaluation that the rotated X-ray source image (X-ray target image) contains less information than the non-rotated X-ray source image. This information loss can be expressed as, among other things, a loss of contrast or resolution. In order to avoid a notable reduction of image quality parameters of the X-ray target image, in accordance with the present invention the pixel values of the source pixels of the X-ray source image are weighted on the basis of a non-linear weighting function for determining the pixel values, i.e. the color values or grayscale values, of the target pixels of the X-ray target image. As used herein a “weighting function” is a function that represents the relationship between the overlap area of the back-transformed target pixel with a relevant source pixel and the weighting of the pixel value of the overlapped, relevant source pixel.

The following applies for the determination of a non-linear weighting function that is suited therefor:

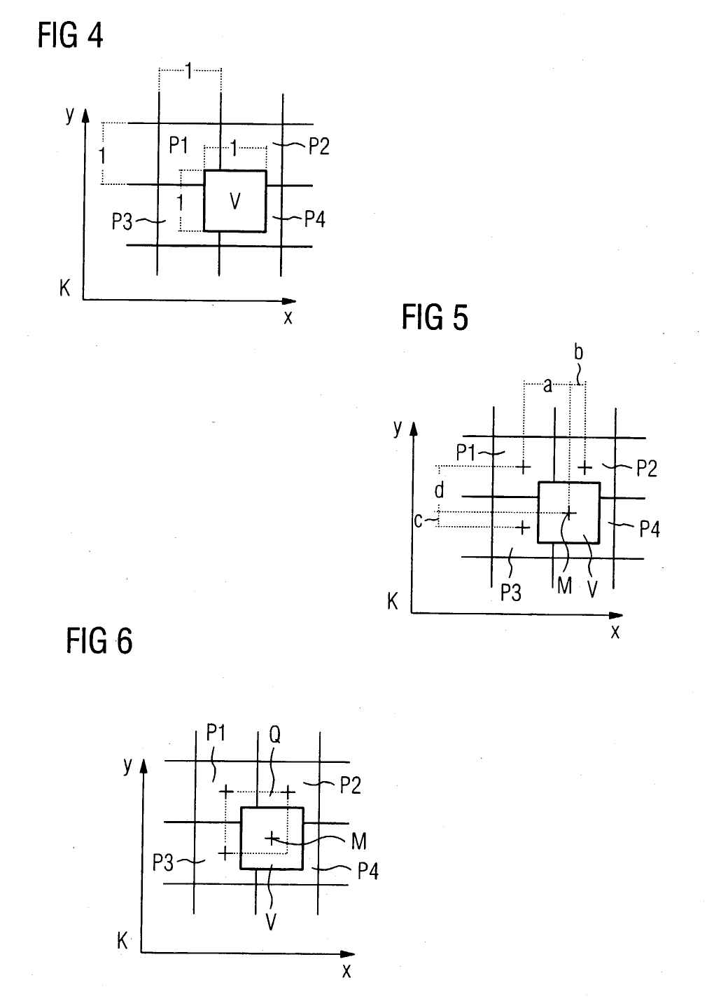

As can be seen from FIG. 2, the back-transformed target pixel of the X-ray target image considered as an example (referred to below as virtual source pixel V) is obtained, for example, by a back-rotation of a target pixel of the X-ray target image into the X-ray source image. The four real source pixels on which the virtual source pixel V comes to lie in the present case are referenced P 1 through P4. This example is based on the Cartesian coordinate system with the two coordinate directions x and y shown in FIG. 2 in which the virtual source pixel V lies.

The overlap paths of the virtual source pixel V with the real source pixels P1 through P4 in the horizontal direction, i.e. in the x-direction, and in the vertical direction, i.e. the y-direction, are indicated as x_{Pi} and y_{Pi}. FIG. 3 shows the overlap path x_{P2} of the virtual source pixel V with the real source pixel P2 in x-direction and the overlap path y_{P3} with the real source pixel P3 in the y-direction.

No simple statement can be made about the relationship of the overlap area parts of the four source pixels P1 through P4. It is simpler to make a statement about the relationships split into the x-direction and y-direction, as illustrated in FIG. 4.

The width (x-direction and the height (y-direction) of a real source pixel P1 through P4 can be assumed with a normalized value of one just like the width (x-direction) and the height (y-direction) of the virtual source pixel V. The following consequently applies:

x_{P3}=x_{P1}

x_{P2}=x_{P4}1-x_{P1}

y_{P2}=y_{P1}

y_{P3}=y_{P4}=1-y_{P1} Equations (1)

Other values or other relationships given an aspect ratio unequal to 1:1 are, of course, conceivable but fundamentally do not influence further considerations.

Since the real source pixels P1 through P4 are one unit wide and high, the sum of the distances a and b in the x-direction and the sum of the distances c and d in the y-direction between real and virtual source pixel according to FIG. 5 is likewise always one.

According to FIG. 6, the mid-point M of the virtual source pixel V is always within the square Q entered in FIG. 6 that is formed by the mid-points of the real source pixels P1 through P4. If the mid-point M of the virtual source pixel V were located outside the square V, then other real source pixels would be required for the interpolation.

The way in which coordinate sections must be subtracted from one another so that a positive result can be expected without further consideration of the operational sign is known with these statements.

Instead of applying one weighting function dependent on the overlap area of a virtual source pixel with a relevant source pixel, it is permissible to apply two weighting functions dependent on the overlapped path in the x-direction and the y-direction of the Cartesian coordinate system K when the two weighting functions are subsequently multiplicatively operated for determining the weights of the source pixels. Since neither the x-direction nor the y-direction represents a privileged direction, it makes sense to apply the same function for both directions. Accordingly, the following applies:

$$w = {\sum }_{i} {w}_{Pi} = {\sum }_{i} f ( {a}_{Pi} ) = {\sum }_{i} f ( {x}_{Pi} ) * f ( {y}_{Pi} ) \qquad \text{Equation (2)}$$

with w: sum of the weights

wₚᵢ: weight of the real source pixel Pᵢ

aₚᵢ: area part of the real source pixel Pᵢ

xₚᵢ: path part in x-direction of the real source pixel Pᵢ

yₚᵢ: path part in y-direction of the real source pixel Pᵢ

or, in the long version:

$$w = f ( {x}_{P1} ) * f ( {y}_{P1} ) + f ( {x}_{P2} ) * f ( {y}_{P2} ) + f ( {x}_{P3} ) * f ( {y}_{P3} ) + f ( {x}_{P4} ) * f ( {y}_{P4} ) \qquad \text{Equation (3)}$$

The following is derived by applying Equations (1):

f(xₚ₁)=f(x_{P3})

f(1-x_{P1})=f(x_{P2})=f(x_{P4})

f(yₚ₁)=f(y_{P2})

f(1-yₚ₁)=f(y_{P3})=f(y_{P4}) Equations (4)

The following applies therefrom and from the condition that the sum of the weights yields the value one:

$$w = 1 = f ( {x}_{P1} ) * f ( {y}_{P1} ) + f ( 1 - {x}_{P1} ) * f ( {y}_{P1} ) + f ( {x}_{P1} ) * f ( 1 - {y}_{P1} ) + f ( 1 - {x}_{P1} ) * f ( 1 - {y}_{P1} ) \qquad \text{Equation (5)}$$

Any other value could be demanded for w, however, a normalization (division) is no longer required after the determination of the sum of the weights with a value of w=1.

The following assumption is then made for the weighting function:

f(z)=1-f(1-z) Equation (6)

with z: in general standing for x and y in the present case,

and the correctness thereof is subsequently checked:

$$w = 1 = f ( {x}_{P1} ) * f ( {y}_{P1} ) + ( 1 - f ( {x}_{P1} ) ) * f ( {y}_{P1} ) ) + f ( {x}_{P1} ) * ( 1 - f ( {y}_{P1} ) ) + ( 1 - f ( {x}_{P1} ) ) * ( 1 - f ( {y}_{P1} ) ) , \qquad \text{Equation (7)}$$

multiplied out:

$$w = 1 = f ( {x}_{P1} ) f ( {y}_{P1} ) + f ( {y}_{P1} ) - f ( {x}_{P1} ) f ( {y}_{P1} ) + f ( {x}_{P1} ) - f ( {x}_{P1} ) f ( {f}_{P1} ) + 1 - f ( {x}_{P1} ) - f ( {y}_{P1} ) + f ( {x}_{P1} ) f ( {y}_{P1} ) = 1 \qquad \text{Equation (8)}$$

The assumption made in Equation (6) is thus correct. The following can now be postulated for the application of the weighting functions in the x-direction and the y-direction: the sum of the weights is one when:

f(x_{Pi})=1-f(1-x_{Pi})

f(y_{Pi})=1-f(1-y_{Pi}) Equations (9).

Every function that satisfies the rule of Equation (9) within its relevant definition range [0; 1] is fundamentally suitable as weighting function. The graphs of these functions have in common the fact that they are point-symmetrical to those coordinates in a Cartesian coordinate system that lie exactly in the middle of the definition range and of the value range. In the present case of a normalized definition range [0; 1] and normalization of the value range [0; 1] resulting therefrom, a necessary point symmetry of the graphs of the weighting functions to the coordinates (0.5; 0.5) proves to be an adequate criterion.

These statements are also valid for discretely defined functions, which must usually be employed in a computing machine for performance reasons, insofar as an element (1-z_{Pi}) was discretely defined for each discretely defined element (z_{Pi}).

Any arbitrary function f_{z}(z) is thus conceivable as weighting function, even those that are not steady or that cannot be steadily differentiated and do not initially exhibit the required symmetry. The symmetry would merely have to be “artificially” produced by section-by-section definition and application of Equations (9):

$$f ( z ) = \{ \begin{matrix} {f}_{z} ( z ) & for & 0 \leq z \leq 0.5 \\ 0.5 & for & z = 0.5 \\ 1 - {f}_{z} ( 1 - z ) & for & 0.5 < z \leq 1\end{matrix} \qquad Equation ( 10 )$$

As has already been stated, every function can be converted into a weighting function by means of a suitable modification. Further requirements are to be defined, however, so that the weighting function fulfills its actual purpose.

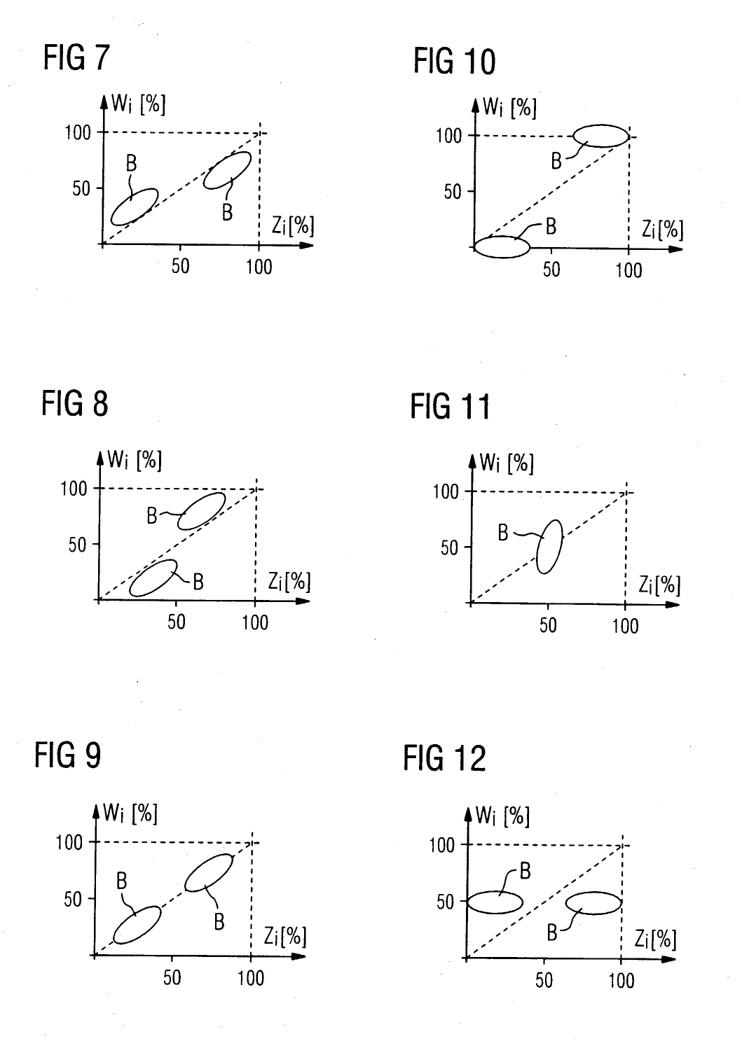

If the graph of a weighting function were situated in the regions B identified in FIG. 7, source pixels having a slight overlap area with the virtual source pixel would receive an over-proportional weight compared to the bi-linear interpolation entered with broken lines. This, however, is exactly what is not wanted.

In the case illustrated in FIG. 8, pixel values of source pixels that comprise a large overlap area with the virtual source pixel would receive an over-proportional weight, whereas pixel values of source pixels that comprise a small overlap area with the virtual source pixel would be under-proportionally taken into consideration in the determination of the weight sum. This corresponds to the above-discussed objective.

When the graph of a weighting function, as shown in FIG. 9, lies on or close to the straight line through the coordinates (0; 0) and (1; 1), then a largely proportional weighting occurs over the entire region of possible overlap areas. This situation corresponds to bi-linear interpolation.

The nearest neighbor method is better simulated the better the graph of a weighting function proceeds close to the extreme values over an optimally broad region B according to FIG. 10. In the extreme case, path sections <50% have the weighting 0 and path sections >50% have the value 1. In the multiplicative operation of the equations for the path sections in x-direction and y-direction, exactly one real source pixel will receive the weighting 1*1, whereas the other real source pixels receive 1*0, 0*1 and 0*0. Exactly one real source pixel thus has the greatest path section of all four real pixels in the x-direction as well as in the y-direction. The point (0.5; 0.5) covers that case wherein path sections are equal in length in one or in both directions.

The obtainable contrast or the severity of the step effect is controlled with the steepness of the graph of a weighting function in the region B entered in FIG. 11. The effects become more pronounced, and the technique becomes closer to the nearest neighbor method, the steeper the curve is in this region.

If the graph of a weighting function remains decidedly in the regions B entered in FIG. 12, then all real source pixels are identically weighted largely independently of their overlapped paths or their overlap area. This corresponds to an averaging over the four real source pixels without weighting.

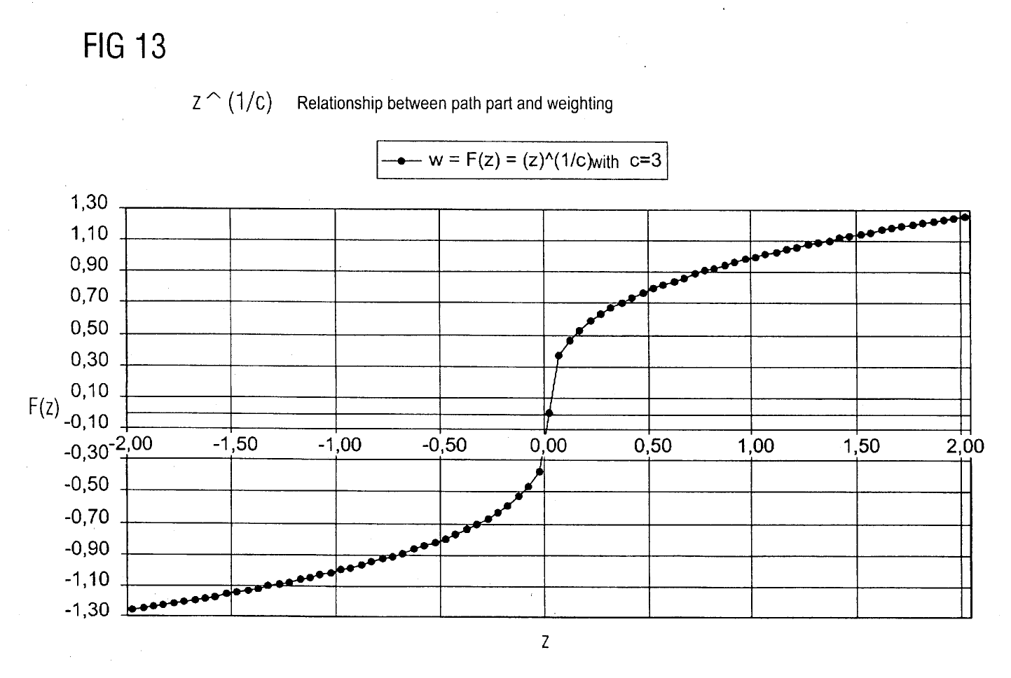

Based on these considerations, various functions are suited for serving as a non-linear weighting function insofar as the graph of the non-linear weighting function proceeds within the envelope that is demarcated by the same definition range and value range from the corresponding graph illustrating the nearest neighbor method and the corresponding graph of the bi-linear method. Examples are an arc-tan function shifted by the x-direction and y-direction and normalized to the value range [0; 1], or a function having the form f(z)=z^{1/c}. The latter is simpler to calculate online and shall be utilized for further consideration. The graph of the function f(z)=z^{1/c} is shown in FIG. 13 with c=3.

The function is point-symmetrical relative to the source, so that it must first be shifted by the vector

$$\vec{V} = ( \begin{matrix}b \\ d\end{matrix} ) = ( \begin{matrix}0.5 \\ 0.5\end{matrix} )$$

so that it meets the demands that the definition range lies between [0; 1] and the function is point-symmetrical relative to the point (0.5; 0.5). By means of varying the exponent c or 1/c, the steepness in the zero-axis crossing can be varied, and thus the actual characteristic can be determined (likelier nearest neighbor [symbol] likelier bi-linear interpolation). A multiplicative factor a, finally, is required for normalization to the permissible value range, so that the following relationship exists:

f(z_{Pi})=a*(z-b)^{1/c}-d Equations (11)

and, taking the shift vector into consideration:

f(z_{Pi})=a*(z-0.5)^{1/c}−0.5 Equations (12)

If the graph of the function is always supposed to proceed through the points (0; 0) and (1; 1), then the factor a is dependent on the exponent 1/c.

$$f ( 1 ) = 1 = {{a}^{*} ( 1 - 0.5 )}^{1 / c} - 0.5 \\ 0.5 = {a}^{*} {0.5}^{1 / c} \\ a = \frac{{2}^{1 / c}}{2} \qquad \text{Equations (13)}$$

Result:

A weighting function having the form

$$f ( z ) = \frac{{2}^{1 / c}}{2} * {( z - 0.5 )}^{1 / c} + 0.5 \qquad Equations ( 14 )$$

is employed. The sole parameter is thereby c. The following applies:

| c is | Significance |
|---|---|
| c < 0 | valid, but not meamngful. |
| c −> 0 | valid, but not very meaningful. All pixels are identically weighted regardless of their area part. |
| c = 0 | illegal |
| 0 < c < 1 | valid, but not meaningful. Small path (area) parts are over-proportionally weighted |
| c = 1 | realization of bi-linear interpolation |
| c > 1 | realization of bi-non-imear interpolation. Different characteristics can be realized dependent on the variation of the value |
| c >> 1 | realization of the nearest neighbor method |

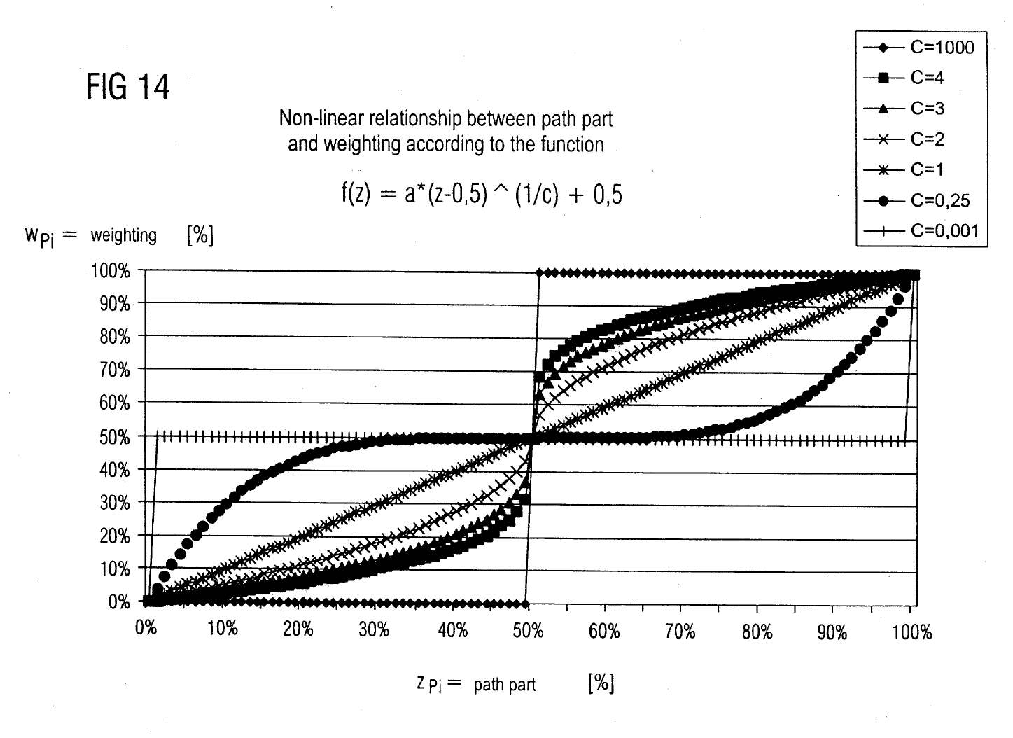

Graphs of this weighting function are entered in FIG. 14 for various values of c. As can be seen from FIG. 14, the graphs of the suitable non-linear weighting functions lie within an envelope that is bounded by the graph (parameter c=1000) illustrating the nearest neighbor method and the graph of the bi-linear method (parameter c=1).

After a determination of the overlap paths that the virtual source pixel V comprises with each of the source pixels P1 through P4 in the x-direction and the y-direction of the Cartesian coordinate system K, thus, weightings of the pixel values of the source pixels P1 through P4 can be undertaken with the assistance of such a suitable weighting function. For determining the weight of a pixel value of a source pixel Pᵢ with i=1-4, the function value for the overlap path in x-direction is acquired on the basis of the equation

$$f ( x ) = \frac{{2}^{1 / c}}{2} * {( y - 0.5 )}^{1 / c} + 0.5 \qquad Equation ( 15 )$$

and the function value for the overlap path in y-direction is acquired on the basis of the equation

$$f ( y ) = \frac{{2}^{1 / c}}{2} * {( y - 0.5 )}^{1 / c} + 0.5 \qquad Equation ( 16 )$$

The product of the two function values ultimately yields the weight for the pixel value of the source pixel Pᵢ. When the weights for the pixel values of the source pixels P1 through P4 have been determined in this way, the pixel value of each source pixel Pᵢ is multiplied by its weight and the results are added. The result of the addition is the pixel value of the virtual source pixel V, i.e., the pixel value of the target pixel of the X-ray target image. This procedure is repeated until the pixel values of all target pixels of the X-ray target image have been determined. The determination of the pixel values of the target pixels of the X-ray target image ensues after initiation of the affinity transformation, automated by the computing device 2 according to this method.

In order to be able to utilize this method for determining the pixel values of the target pixels of an X-ray target image in high-performance computing device, for example a DSP (digital signal processor), weighting matrices are determined according to the invention and stored in the memory 5 of the computing device 2. The weighting matrices are employed as look-up table in the determination of the pixel values of the target pixels of an X-ray target image. It is only with such weighting matrices that a multitude of X-ray target images can be calculated according to affinity transformations in a short time and presented on the viewing device 4, this being referred to as an image pipeline. For example, such a pipeline is operated with 25 or 30 images per second. Given employment of a CCD camera with approximately 1024*1024 pixels and a resolution of 12 bits per pixel, this yields 25 or 30 mega-pixels/s, o a payload data stream of 300 or 360 Mbits/s.

In the dimensioning of a weighting matrix, the resolution or the rastering of the desired weighting must be taken into consideration. A step width of approximately 5% of a pixel width is meaningful since the determination of the mid-point M of the virtual source pixel V lies on this order of magnitude.

Further, the computing steps after the weighting must be taken into consideration. The weights are stored for this purpose in a weighting matrix as fixed-point values. So that a normalization to a new pixel point presentation can ensue after the multiplication by the pixel value of a relevant source pixel, the number of rows and columns of a weighting matrix should always correspond to a power of two. A 32's rastering of a weighting matrix is achieved with this condition.

The graph of a weighting function always proceeds through the coordinates (0; 0) and (1; 1). In order to also be able to cover these cases with a weighting matrix without discriminating between cases, the weighting matrix is expanded by one column and one row with zeroes in order to incorporate the values 0 and 1. A weighting matrix of 33 rows and 33 columns thus is derived.

The precision (=bit depth) of the individual matrix values or weights should be designed such that no losses of information arise due to the multiplication of the weights. Thus it always should be twice the size as the calculation of the Equation (6), or the Equations (9), since artificial asymmetries in a weighting matrix otherwise would be generated at this location.

As can be seen from Equations (9), the symmetry relationships represent a significant element in the weighting functions, and thus in the weighting matrix as well. So that weight sums unequal to one do not arise due to rounding imprecisions,

the function values according to Equation (14) are fundamentally calculated over only half the definition range, including edge value without the value at the position 0.5;

the function value at the position 0.5 is always set to 0.5 by definition; and

the lacking function values of the definition range that has not yet been calculated are determined from the function values of the calculated function range according to Equation (6).

The multiplicative operation of the weighting functions for all defined overlap paths in the x-direction and the y-direction yield the weighting matrix. Ultimately following from Equation (14)

$$f ( z ) = \frac{{2}^{1 / c}}{2} * {( z - 0.5 )}^{1 / c} + 0.5$$

is Equation (17) for calculating the matrix elements or, respectively, the weights of a weighting matrix:

$$f ( x , y ) = ( \frac{{2}^{1 / c}}{2} * {( x - 0.5 )}^{1 / c} + 0.5 ) * ( \frac{{2}^{1 / c}}{2} * {( y - 0.5 )}^{1 / c} + 0.5 )$$

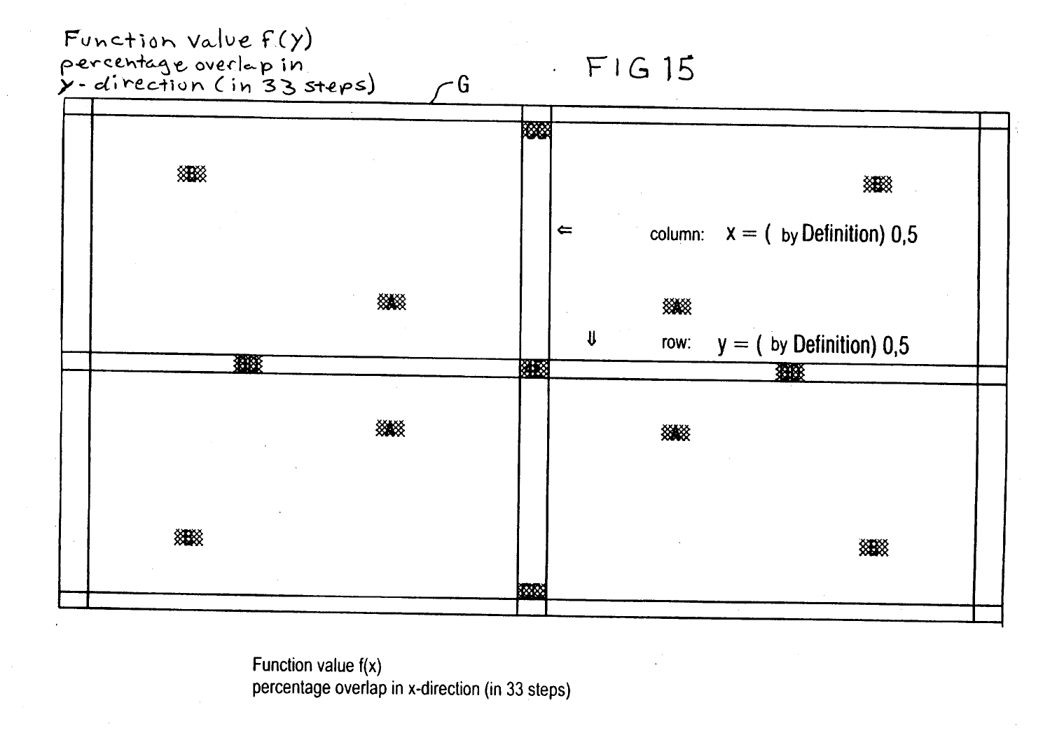

FIG. 15 schematically provides examples of the application of a weighting matrix. It should be noted that the relevant weights of the weighting matrix for the four real source pixels are always arranged point-symmetrically to the mid-point of the weighting matrix. Four elements of the table are always used, with the special case that elements of the middle column or, respectively, row are always doubled employed and thereby the further special case that the mid-point of the table is employed four times.

Five independent examples are entered in FIG. 15:

A: The four fields referenced “A” are located relatively close to the mid-point of the weighting matrix.

The virtual source pixel is located close to the middle of the four real source pixels.

B: The four fields referenced “B” are located relatively close to the edge of the weighting matrix.

The virtual source pixel is located almost completely over a source pixel. This virtual source pixel is mainly weighted with the pixel value under the upper “B” at the right. The pixel values of the other source pixels are only lightly weighted.

C: The two fields referenced “CC” are located in the middle column of the weighting matrix.

The virtual source pixel is located in the middle of the two right and left real source pixels (equal x-component).

D: The two fields referenced “DD” are located in the middle row of the weighting matrix.

The virtual source pixel is located in the middle of the two upper and lower source pixels (equal y-part).

E: The one field referenced with “4E” is located exactly in the middle of the weighting matrix.

The virtual source pixel is located exactly in the middle of the four real source pixels (equal x and y components).

The following also applies:

The function values f(0, y) are always 0=>no overlap in the x-direction.

The function values f(x, 0) are always 0=>no overlap in the y-direction,

The function value f(Xₘₐₓ, Yₘₐₓ) is always 1=>complete overlap.

The function value f(xₘₐₓ/2, yₘₐₓ/2) is always 0.25=>equal weighting of all real source pixels.

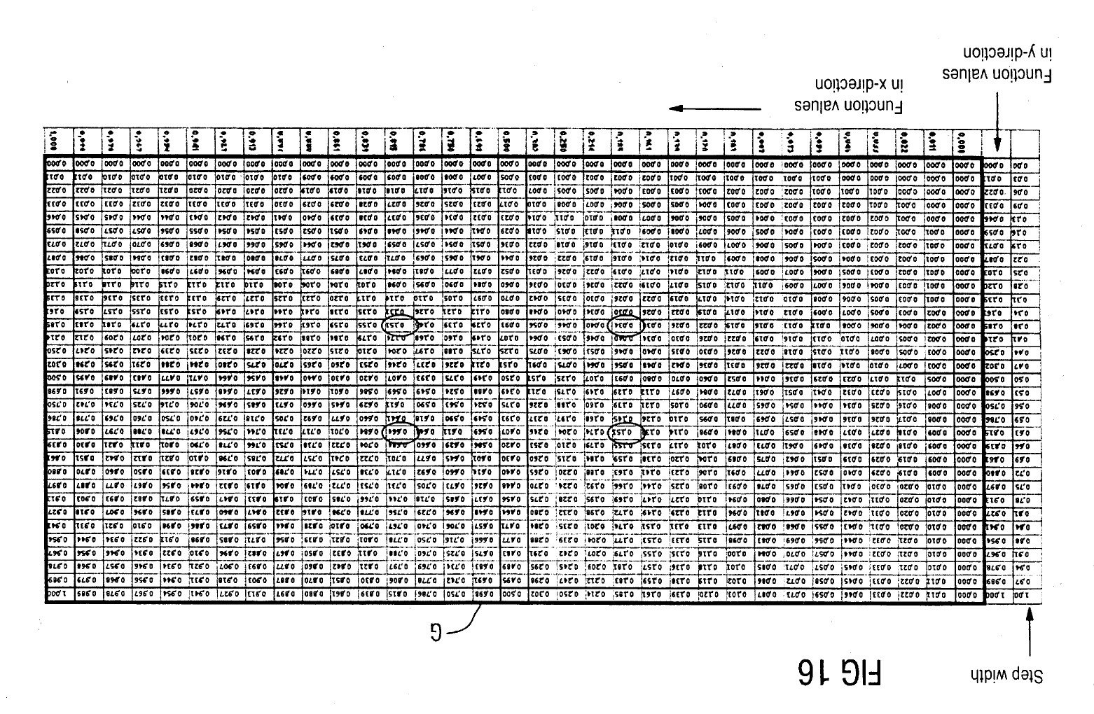

FIG. 16 shows a real weighting matrix G determined with Equation (17). The value 3.0 was selected for the parameter c. The step width for the determination of the weights amounts to (1/32)=(0.03125) in the x-direction and in the y-direction, rounded to two post-decimal places. The step width in FIG. 16 is only indicated vertically (y-values). This step width, however, was also selected for the x-values. The function values of the weighting functions f(x) and f(y) calculated on the basis of Equations (15) and (16) are indicated rounded to three post-decimal places both vertically as well as horizontally. The weights of the weighting matrix G calculated from the function values are likewise indicated rounded to three post-decimal places. The weighting matrix G comprises a point symmetry relative to the matrix element of the row and column 17 having the weight 0.250. The employment of the weighting matrix G in the determination of the weights for four relevant source pixels, for example, ensues such that—following a determination of the overlap paths in x-direction and y-direction of a virtual source pixel V with real source pixels P1 through P4—the weight 0.664 is taken from the weighting matrix G for a real source pixel P4 that, for example, comprises an overlap path of 0.815 in x-direction and an overlap path of 0.815 in y-direction. The three other weights derive as 0.151, 0.034 and 0.151 from the symmetry of the weighting matrix. These can be allocated to the three remaining, real source pixels P1 through P3 on the basis of the overlap paths. Taking FIG. 2 into consideration, for example, the pixel values of the source pixel P4 would be multiplied by the weight 0.664, the pixel values of the source pixel P3 would be multiplied by the weight 0.151, the pixel values of the source pixel P2 would be multiplied by the weight 0.151 and the pixel values of the source pixel P1 would be multiplied by the weight 0.034. The addition of the four results of the four products, finally, yields the pixel value of the virtual source pixel V or, respectively, of the back-transformed target pixel and, thus, of the appertaining target pixel of the X-ray target image. All pixel values of the target pixels of an X-ray target image that has proceeded from an affinity transformation of an X-ray source image can be calculated according to this method.

Various weighting matrices can be determined for various values of the parameter c and be deposited in the memory 2 of the computing device in order to be able to employ these as look-up table in the determination of the pixel values of target pixels of an X-ray target image. Dependent on the application, i.e. based on the desired imaging properties (which can be influenced by the selection of the parameter c), the weighting matrix that is suitable therefor and produced with the corresponding parameter c can be utilized for determining the pixel values of target pixels of an X-ray target image. This enables a gradual adaptation of the properties of the pixel value interpolation to the current requirements. The realization in the form of a normalized weighting matrix on the basis of a non-linear weighting function enables employment in high-performance computing devices, whereby the transformation parameters can be varied online by means of a corresponding selection of a weighting matrix. Overall, an improved image quality (contrast, spatial resolution) can be achieved by employing a non-linear weighting function for weighting pixel values as well as by adapting the weighting by selecting a suitable weighting matrix given affinity transformations.

The invention was explained above on the basis of pixel-based X-ray images. The application of the invention, however, is not limited to pixel-based X-ray images but can be employed in affinity transformations of pixel-based images that were acquired in any way whatsoever.

Although modifications and changes may be suggested by those skilled in the art, it is the intention of the inventor to embody within the patent warranted hereon all changes and modifications as reasonably and properly come within the scope of his contribution to the art.

I claim as my invention:

1. For a target image composed of target pixels, generated by an affinity transformation of a source image, comprised of source pixels each having a source pixel value, a method for determining a target pixel value of a target pixel of the target image, comprising the steps of:
inversely transforming a pixel in said target image into the source image and thereby producing a back-transformed target pixel overlapping a plurality of source pixels with respective overlap areas;
for each of said plurality of source pixels overlapped by said back-transformed target pixel, determining said overlap area and weighting that source pixel with a non-linear weighting function representing a relationship between the overlap area and the source pixel value of that source pixel, by multiplying the source pixel value of that source pixel by said weighting function, to obtain a weighted source pixel value;
demarcating a graph of said weighting function with an envelope formed by a definition and value range for a nearest neighbor interpolation method and a bi-linear interpolation method for said affinity transformation; and
forming said target pixel value for said target pixel by summing the respective weighted source pixel values of said plurality of source pixels overlapped by said back-transformed target pixel.

2. A method as claimed in claim 1 comprising defining said non-linear weighting function so that said sum of the respective weighted source pixel values is one.

3. A method as claimed in claim 1 wherein said overlapped area contains two overlapped paths respectively in two coordinate directions of a Cartesian coordinate system, said two coordinate directions defining a plane in which said back-transformed target pixel is disposed, and comprising the additional steps of determining the respective overlap paths in said coordinate directions, with said non-linear weighting function being a first non-linear weighting function dependent on a first of said coordinate directions, employing a second non-linear weighting function dependent on a second of said coordinate directions, and for each of said plurality of source pixels overlapped by said back-transformed target pixel, determining a first function value from said overlapped path in said first of said coordinate directions and said first non-linear weighting function and determining a second function value from the overlapped path in said second of said coordinate directions and said second non-linear weighting function, and weighting that source pixel with a weight formed by a product of said first function value and said second function value.

4. A method as claimed in claim 3 wherein said first non-linear weighting function is
$$f ( x ) = \frac{{2}^{1 / c}}{2} * {( x - 0.5 )}^{1 / c} + 0.5 ,$$
wherein x is a function variable along said first of said coordinate directions and wherein c is a selectable parameter, and wherein said second non-linear weighting function is
$$f ( y ) = \frac{{2}^{1 / c}}{2} * {( y - 0.5 )}^{1 / c} + 0 ,$$
wherein y is a function variable along said second of said coordinate directions.

5. A method as claimed in claim 3 wherein said first non-linear weighting function is f(x) wherein x is a function variable along said first of said coordinate directions having a definition range [0:1], and wherein said second non-linear weighting function is f(y), wherein y is a function variable along said second of said coordinate directions in a definition range [0:1], and comprising the additional step of forming a weighting matrix having a plurality of matrix elements forming an equal number of rows and columns, with the respective matrix elements being said product with x and y respectively varying in equidistant steps in the respective definition range.

6. A method as claimed in claim 5 comprising defining f(x)=f(0.5)=0.5 and f(y)=f(0.5)=0.5.

7. A method as claimed in claim 5 comprising directly calculating each of f(x) and f(y) over only half of the respective definition range, and calculating f(x) over a remaining half of said definition range as f(x)=1-f(1-x), and calculating f(y) over a remaining half of said definition range as f(y)=1-f(1-y).

8. A method as claimed in claim 5 comprising setting said equidistant steps as having a width of approximately 5% of a width of said source pixel.

9. A method as claimed in claim 5 comprising forming said weighting matrix with a number of columns and a number of rows each equal to a power of two.

10. A method as claimed in claim 9 comprising augmenting said weighting matrix with a row of zeros and a column of zeros.

11. A method as claimed in claim 1 comprising employing f(z)=1-f(1-z) as said non-linear weighting function, wherein z is a function variable.

12. A method as claimed in claim 1 comprising employing a non-linear weighting function having a definition range [0:1], with said non-linear weighting function being point-symmetrical in said definition range [0:1], said point being a point in a Cartesian coordinate system disposed in a middle of said definition range and a middle of said value range of said non-linear weighting function.

13. A method as claimed in claim 12 comprising defining said non-linear weighting function so that the slope of the tangent of said symmetry point is in a middle of said definition range and a middle of said value range of said non-linear weighting function is set by a parameter of said non-linear weighting function.

14. A method as claimed in claim 1 comprising employing a discrete function as said non-linear weighting function.

15. A method as claimed in claim 1 comprising employing a non-linear weighting function which over-proportionally weights source pixels in said plurality of source pixels overlapped by said back-transformed target pixel having an overlap area which is larger compared to respective overlap areas of other source pixels in said plurality, and under-proportionally weights source pixels in said plurality of source pixels overlapped by said back-transformed target pixel having an overlap area which is small compared to respective overlap areas of other source pixels in said plurality.

16. A method as claimed in claim 15 wherein said non-linear weighting function has a parameter, and using said parameter to set the respective weights of said source pixels in said plurality of source pixels overlapped by said back-transformed target pixel.

17. For a target image composed of target pixels, generated by an affinity transformation of a source image, comprised of source pixels each having a source pixel value, a computing device programmed to determine a target pixel value of a target pixel of the target image, by:
inversely transforming a pixel in said target image into the source image and thereby producing a back-transformed target pixel overlapping a plurality of source pixels with respective overlap areas;
for each of said plurality of source pixels overlapped by said back-transformed target pixel, determining said overlap area and weighting that source pixel with a non-linear weighting function representing a relationship between the overlap area and the source pixel value of that source pixel, by multiplying the source pixel value of that source pixel by said weighting function, to obtain a weighted source pixel value;
demarcating a graph of said weighting function with an envelope formed by a definition and value range for a nearest neighbor interpolation method and a bi-linear interpolation method for said affinity transformation; and
forming said target pixel value for said target pixel by summing the respective weighted source pixel values of said plurality of source pixels overlapped by said back-transformed target pixel.

18. A calculating device as claimed in claim 17 programmed to define said non-linear weighting function so that said sum of the respective weighted source pixel values is one.

19. A calculating device as claimed in claim 17 wherein said overlapped area contains two overlapped paths respectively in two coordinate directions of a Cartesian coordinate system, said two coordinate directions defining a plane in which said back-transformed target pixel is disposed, and wherein said calculating device is programmed to determine the respective overlap paths in said coordinate directions, with said non-linear weighting function being a first non-linear weighting function dependent on a first of said coordinate directions, to employ a second non-linear weighting function dependent on a second of said coordinate directions, and for each of said plurality of source pixels overlapped by said back-transformed target pixel, to determine a first function value from said overlapped path in said first of said coordinate directions and said first non-linear weighting function and determine a second function value from the overlapped path in said second of said coordinate directions and said second non-linear weighting, function, and to weight that source pixel with a weight formed by a product of said first function value and said second function value.

20. A calculating device as claimed in claim 19 programmed to employ
$$f ( x ) = \frac{{2}^{1 / c}}{2} * {( x - 0.5 )}^{1 / c} + 0.5$$
as said first non-linear weighting function, wherein x is a function variable along said first of said coordinate directions and to employ
$$f ( y ) = \frac{{2}^{1 / c}}{2} * {( y - 0.5 )}^{1 / c} + 0$$
as said second non-linear weighting function, wherein y is a function variable along said second of said coordinate directions.

21. A calculating device as claimed in claim 19 comprising a memory, and programmed to employ f(x) as said first non-linear weighting function, wherein x is a function variable along said first of said coordinate directions having a definition range [0:1], and to employ f(y) as said second non-linear weighting function, wherein y is a function variable along said second of said coordinate directions in a definition range [0:1], and to form and store, in said memory, a weighting matrix having a plurality of matrix elements forming an equal number of rows and columns, with the respective matrix elements being said product with x and y respectively varying in equidistant steps in the respective definition range.

22. A calculating device as claimed in claim 21 programmed to define f(x)=f(0.5)=0.5 and f(y)=f(0.5)=0.5.

23. A calculating device as claimed in claim 21 programmed to directly calculate each of f(x) and f(y) over only half of the respective definition range, and to calculate f(x) over a remaining half of said definition range as f(x)=1-f(1-x), and to calculate f(y) over a remaining half of said definition range as f(y)=1-f(1-y).

24. A calculating device as claimed in claim 21 programmed to set said equidistant steps as having a width of approximately 5% of a width of said source pixel.

25. A calculating device as claimed in claim 21 programmed to form and store said weighting matrix with a number of columns and a number of rows each equal to a power of two.

26. A calculating device as claimed in claim 25 programmed to augment said weighting matrix in said memory with a row of zeros and a column of zeros.

27. A calculating device as claimed in claim 17 programmed to employ f(z)=1-f(1-z) as said non-linear weighting function, wherein z is a function variable.

28. A calculating device as claimed in claim 17 programmed to employ a non-linear weighting function having a definition range [0:1], with said non-linear weighting function being point-symmetrical in said definition range [0:1], said point being a point in a Cartesian coordinate system disposed in a middle of said definition range and a middle of said value range of said non-linear weighting function.

29. A calculating device as claimed in claim 28 programmed to define said non-linear weighting function so that the slope of the tangent of said symmetry point is in a middle of said definition range and a middle of said value range of said non-linear weighting function is set by a parameter of said non-linear weighting function.

30. A calculating device as claimed in claim 17 programmed to employ a discrete function as said non-linear weighting function.

31. A calculating device as claimed in claim 17 programmed to employ a non-linear weighting function which over-proportionally weights source pixels in said plurality of source pixels overlapped by said back-transformed target pixel having an overlap area which is larger compared to respective overlap areas of other source pixels in said plurality, and under-proportionally weights source pixels in said plurality of source pixels overlapped by said back-transformed target pixel having an overlap area which is small compared to respective overlap areas of other source pixels in said plurality.

32. A calculating device as claimed in claim 31 wherein said non-linear weighting function has a parameter and wherein said calculating device is programmed to use said parameter to set the respective weights of said source pixels in said plurality of source pixels overlapped by said back-transformed target pixel.
